(19) United States
(12) Patent Application Publication
(10) Pub. No.: US 2026/0213631 A1
(43) Pub. Date: Jul. 23, 2026

(54) Winding machine and method for producing coil windings on an externally grooved winding support of a rotor or stator of an electrical machine, and winding system

(71) Applicant: Aumann Espelkamp GmbH, Espelkamp (DE)

(72) Inventor: Jürgen HAGEDORN, Espelkamp (DE)

(73) Assignee: Aumann Espelkamp GmbH, Espelkamp (DE)

(21) Appl. No.: 19/140,135

(22) PCT Filed: Dec. 1, 2023
(86) PCT No.: PCT/DE2023/100934

§ 371 Date: Jun. 17, 2025

(30) Foreign Application Priority Data
Dec. 22, 2022 (DE) 102022134579.3

(51) Int. Cl. H02K 15/095; B21F 23/00

(52) U.S. Cl. CPC H02K 15/095; B21F 23/00

(57) ABSTRACT

A winding machine for producing coil windings of a rotor or stator. The winding machine comprises a receiving device for receiving an externally grooved winding support and a plurality of winding devices arranged around the receiving device. The winding devices have a wire supply means to move a winding wire to the receiving device. Each of the winding devices has a drive system to move the wire supply means relative to the receiving device such that the winding wire is wound around a winding tooth of an externally grooved winding support received on the receiving device. The receiving device has a rotational drive to rotate the receiving device such that the respective winding wire is wound around the relevant winding tooth. Furthermore, a winding system having a plurality of winding machines and a method for producing coil windings are provided.

The invention relates to a winding machine and a method for producing coil windings on an externally grooved winding support of a rotor or stator of an electrical machine and to a winding system.

### BACKGROUND

Rotors, in particular externally grooved rotors, for electric motors designed in particular as separately excited synchronous machines are usually formed with teeth which are each wound with a copper wire, for example an enameled copper wire, in the form of a concentrated winding. In the region of the traction drives, as a rule four to eight teeth are provided for such a rotor. The windings of the individual teeth are as a rule designed as a series circuit and thus have a total of two connecting wires which are widely connected electrically to a slip ring body. The internal interconnection of the individual toothed coils takes place here in the winding process itself. It is known from the prior art that rotors are wound with a wire guide and the simple feeding of the enameled copper wire in a lying or also standing manner tooth by tooth.

So-called needle winding machines are widely used for winding, in which wire is wound around a tooth by means of a needle-shaped feed in order to form coil windings. Such a system is described in document EP 1 191 672 B1. Documents WO 2015/189676 A1 and EP 1 376 829 B1 disclose devices in which a plurality of teeth of an internally grooved winding support can be wound by means of needles driven in a jointly coupled manner.

### SUMMARY

The object of the invention is to provide improved technologies for producing coil windings on an externally grooved winding support, with which, in particular, effective and efficient winding is made possible.

In order to achieve the object, a winding machine for producing coil windings on an externally grooved winding support of a rotor or stator of an electrical machine is created according to independent claim 1. Furthermore, methods for producing coil windings on an externally grooved winding support of a rotor or stator of an electrical machine and a winding system according to further independent claims are provided. Embodiments are the subject matter of dependent claims in the appended set of claims.

According to one aspect, a winding machine for producing coil windings on an externally grooved winding support of a rotor or stator of an electrical machine is created. The winding machine comprises a receiving device for receiving an externally grooved winding support and a plurality of winding devices arranged around the receiving device. The receiving device has a longitudinal axis which, in a state in which an externally grooved winding support is received on the receiving device, lies on a longitudinal axis of the externally grooved winding support. Each of the winding devices has a wire supply means which is configured to move a winding wire along a feed direction and thus to guide the winding wire towards the receiving device. Each of the winding devices has a drive system which is configured to move the wire supply means relative to the receiving device and independently of the wire supply means of the other winding devices during a feed movement of the winding wire in accordance with a winding movement in such a way that the winding wire is wound around a winding tooth of an externally grooved winding support received on the receiving device in order to form a coil winding. The receiving device has a rotary drive by means of which the receiving device is rotatable about its longitudinal axis. The rotary drive is configured to rotate the receiving device in accordance with the winding movement in such a way that the respective winding wire is wound around the respective winding tooth of the externally grooved winding support received on the receiving device in order to form a respective coil winding.

According to a further aspect, a method for producing coil windings on an externally grooved winding support of a rotor or stator of an electrical machine is provided, having the steps of receiving an externally grooved winding support on a receiving device of a winding machine in such a way that a longitudinal axis of the receiving device lies on a longitudinal axis of the externally grooved winding support; and simultaneously forming a plurality of coil windings around a respective winding tooth of the externally grooved winding support by means of a plurality of winding devices of the winding machine which are arranged around the receiving device, wherein in this case, in order to form a respective coil winding by means of a respective winding device, a winding wire is moved along a feed direction by means of a wire supply means of the respective winding device and is thus supplied to the respective winding tooth, during the feed movement of the winding wire, the wire supply means of the respective winding device is moved in accordance with a winding movement by means of a drive system of the respective winding device relative to the respective winding tooth and independently of the wire supply means of the other winding devices and is thus wound around the respective winding tooth, and the externally grooved winding support is rotated in accordance with the winding movement by means of a rotary drive of the receiving device in such a way that the respective winding wire is wound around the respective winding tooth of the externally grooved winding support in order to form the respective coil winding.

A winding system according to a further aspect is formed with a plurality of winding machines according to the disclosure, wherein the winding machines are configured to produce coil windings in parallel on a respective externally grooved winding support of a rotor or stator of an electrical machine in the winding system.

With the technologies according to the disclosure, a plurality of wires can be supplied to a winding support simultaneously, wherein each wire supply means faces a different winding tooth and can operate independently. As a result of the parallel mode of operation, a process time for winding a winding support can be reduced. In particular, it is provided according to the disclosure to operate the winding devices at least temporarily in parallel in time in order to produce a plurality of coil windings at the same time. Preferably, the winding devices are configured for operation substantially completely in parallel in time, which operation is then correspondingly provided for the method. As a result of such winding of a plurality of teeth of a winding support at the same time, in particular in the case of a laminated winding support, slackening of the laminations of the winding support on a side lying opposite an individual wound tooth can be avoided or reduced. According to the disclosure, the production of coil windings can be provided on a laminated externally grooved winding support, that is to say on a winding support which consists of an arrangement, in particular stacking, of a plurality of laminations, the shape of which predefines the outer contour of the winding support.

The configuration of the drive systems and of the rotary drive for movements in accordance with winding movements can comprise, in particular, corresponding actuation by means of one or more actuation devices provided for this purpose. Here, a common actuation device, a respective actuation device for each element generating a movement or a plurality of actuation devices for in each case one or a group of movement-generating elements can be provided.

In preferred embodiments, it can be provided to rotate the receiving device at least partially at the same time as a respective winding movement of the winding devices in accordance with the winding movement by means of the rotary drive. Thus, a winding movement can be carried out via an at least partial superposition of the various provided movements, which winding movements are adapted precisely to a winding support to be wound. For example, a winding wire can be placed precisely around a rounded corner of a winding tooth and/or guided in an obliquely running groove between two winding teeth of an obliquely grooved winding support by means of a superposition of a rotation of the receiving device with a wire supply means movement in the axial direction (that is to say parallel to the longitudinal axis).

The wires can be supplied to the winding machine, and here to the winding devices, from a respective wire store, in particular a respective roll. The wire stores can form part of the winding machines or be arranged outside the latter.

The winding devices are preferably arranged about a longitudinal axis of the receiving device and thus along a circumference of a winding support received in the receiving device.

The winding devices can be configured in accordance with a needle winding technique known per se. In particular, the winding devices can each have a tubular wire supply means which can be referred to as a needle or wire guide nozzle and is configured to be introduced into the intermediate space between two teeth and then to be moved in a manner supplying a coil wire around a tooth in order to produce coil windings.

In the winding machine, the rotation of the receiving device serves to rotate an externally grooved winding support received on the receiving device, with the result that the externally grooved winding support is rotated in accordance with the method according to the disclosure at least partially at the same time as a respective winding movement of the winding devices in accordance with the winding movement by means of the rotary drive in such a way that the respective winding wire is wound around the respective winding tooth of the externally grooved winding support in order to form the respective coil winding. With the reception of an externally grooved winding support on the receiving device of the winding machine, a winding arrangement comprising the winding machine and the winding support can be formed.

The winding machine can have at least three winding devices. For example, the winding machine can have exactly three winding devices. Alternatively, two or more than three winding devices can be provided. In particular, a number of winding devices of the winding machine can be selected in such a way that an available installation space around the receiving device is used efficiently, for example by arranging a maximum possible number of winding devices around the receiving device without the winding devices impeding one another in their respective movements.

The winding devices can be arranged uniformly distributed around the receiving device in relation to the circumference of a winding support to be arranged in the receiving device. Thus, in an embodiment with three winding devices, a respective angle between two adjacent winding devices about the longitudinal axis, or in the circumferential direction of a winding support to be arranged in the receiving device, can be 120 degrees. In the case of more or fewer winding devices, corresponding angles result in the case of uniform distribution.

The receiving device can have a workpiece support which is configured for receiving an externally grooved winding support and is arranged releasably in the winding machine in order to enable a transport of an externally grooved winding support received on the workpiece support to and from the winding machine. Here, it can be provided that the winding support is moved away from the workpiece support during the reception on the receiving device, with the result that the winding support is arranged on the receiving device, but not on the workpiece support, during the winding process. Here, the workpiece support itself can be arranged on the receiving device. The workpiece support can be releasable from the receiving device in order to arrange a winding support on the workpiece support at a distance from the receiving device. In such an embodiment, alternatively, the workpiece support cannot be part of the receiving device, but rather can be provided independently of the latter. In an embodiment, the workpiece support has a recess through which a corresponding holding projection of the receiving device is guided in order to come into contact with the winding support and to receive the latter on the receiving device. Here, the winding support can be moved away from the workpiece support, with the result that the workpiece support remains on the receiving device separately from the winding support and outside the region in which the coil windings are produced. Alternatively, it can be provided that the winding support remains on the workpiece support and is received on the receiving device by virtue of the fact that the workpiece support is fastened to the receiving device. In this case, it can be provided that the rotation of the receiving device about its longitudinal axis is transmitted to the workpiece support, with the result that the latter rotates about a longitudinal axis of the workpiece support, wherein, in turn, the rotation of the workpiece support is transmitted to the winding support in order to achieve a rotation of the winding support, in particular as a constituent part of a winding movement.

For each of the winding devices, the respective drive system can be configured to move the wire supply means in accordance with the winding movement relative to the receiving device in a first direction which runs parallel to the longitudinal axis of the receiving device, and to move the wire supply means in a second direction which runs perpendicularly to the longitudinal axis of the receiving device and through the longitudinal axis of the receiving device. Thus, with respect to a winding support received on the receiving device, an axial movement is provided with the movement in the first direction and a radial movement is provided with the second movement.

The movement of the winding devices in the respective second direction can serve, in particular, to feed the respective wire supply means to a winding support received on the receiving device, for example into an intermediate space between teeth of the winding support. The movement of the winding devices in the respective first direction can serve, in particular, to move the respective wire supply means along and/or through an intermediate space between teeth of a winding support received on the receiving device. By means of the rotation of the receiving device, a relative movement of the winding devices, in particular of the wire supply means of the winding devices, with respect to the winding support in the tangential direction of the winding support can be provided by a resulting rotation of a winding support received on the receiving device. By a combination of the rotation of the receiving device with a movement of a winding device, in particular of the wire supply means of the winding device, a relative movement of the winding device with respect to a winding support received on the receiving device in the circumferential direction of the winding support can be provided.

A winding movement with respect to a tooth to be wound of a winding support received on the receiving device can be realized for each of the winding devices, in which winding movement the wire supply means of the winding device, preferably configured as a wire supply means configured in accordance with the needle winding technique known per se, is introduced into an intermediate space between the tooth to be wound and an adjacent tooth of the winding support, is guided in the axially parallel direction of the winding support through the intermediate space until the wire supply means emerges from the intermediate space in the axially parallel direction of the winding support, is then guided at least partially in the tangential direction and/or circumferential direction of the winding support around an end of the tooth to be wound, is subsequently introduced in the axially parallel direction of the winding support into a further intermediate space between the tooth to be wound and a further adjacent tooth opposite the adjacent tooth, is guided in the axially parallel direction of the winding support through the further intermediate space until it emerges from the further intermediate space, is guided at least partially in the tangential direction and/or circumferential direction of the winding support around an opposite end of the tooth to be wound and is subsequently introduced again in the axially parallel direction of the winding support into the intermediate space between the tooth to be wound and the adjacent tooth of the winding support. Here, wire is then supplied by the wire supply means such that the wire is wound around the tooth to be wound, wherein an individual coil winding is placed around the tooth to be wound with each repetition of the described winding movement.

Each, individual or one of the winding devices can be movable in a third direction which runs perpendicularly to the first direction and perpendicularly to the second direction. Thus, with respect to a winding support received on the receiving device, a tangential movement is provided with the movement in the third direction. In a preferred embodiment, the movement in the third direction is not part of the winding movement. In such an embodiment or in other embodiments, the movement in the third direction can serve to feed the respective wire supply means to or into a winding support received on the receiving device, optionally in interaction with movements in other directions. Alternatively or additionally, the movement in the third direction, optionally in conjunction with movements in other directions, can serve to wind on a contact point of the winding support. In the case of such winding on, it can be provided to guide a free end of a winding wire to a predetermined contact point, in particular a receptacle provided for this purpose, of the winding support and to fix it there. The contact point can be configured to make electrical contact with the winding wire via the contact point, in particular from outside the winding support and/or for producing electrical connections between winding wires arranged on the winding support, in particular winding wires of different windings. Sub-sequent to such a winding-on movement and the fixing of the winding wire on the contact point, the wire supply means can then be brought into a position from which the winding movement begins. In embodiments, the movement in the third direction can be part of the winding movement, in particular alternatively or additionally to a rotation of the receiving device.

Alternatively or additionally to a third direction, each, individual or one of the winding devices can be movable in a fourth direction which runs in the circumferential direction on a circular arc about the longitudinal axis and thus with respect to a winding support received on the receiving device. The movement in the fourth direction can be provided as part of the winding movement and/or independently of the winding movement, in particular as a feed movement and/or winding-on movement.

The movement in the fourth direction can be provided as an alternative to the movement in the second direction. In this case, the respective wire supply means can be fed into an intermediate space between teeth of a winding support received on the receiving device in an axially parallel manner with respect to the winding support.

For each of the winding devices, the drive system can be configured to pivot the wire supply means about a pivot axis which runs perpendicularly to and at a distance from the longitudinal axis of the receiving device. Thus, the pivot axis runs tangentially to a winding support received on the receiving device. In particular, it can thus be provided to pivot a wire supply means configured in accordance with a needle winding technique about the pivot axis as part of a winding movement and/or as part of a feed movement and/or winding-on movement.

Each, individual or one of the winding devices can have a stripping means which is configured to remove insulation of the winding wire. The stripping means is preferably configured to remove insulation of the winding wire selectively in sections, in particular at ends of the winding wire, in order to enable or to simplify electrical contacting. The stripping means can be configured to remove insulation of the winding wire during a feed movement and/or during a standstill of the winding wire. The stripping means can remove the insulation abrasively, by means of one or more milling devices, thermally, in particular by means of a heating device, and/or in another way. An abrasive removal of the insulation can be achieved, for example, by means of rotating blades, for example three or four blades of the stripping means arranged around the wire to be supplied. For example, rotating blades, preferably with diamond cutting edges, can be provided for the stripping means at a rotational speed of 9,000 to 15,000 revolutions per minute.

Each, individual or one of the winding devices can have a wire clamping means which is configured to clamp the winding wire and thus to prevent movement of the winding wire along the feed direction. Preferably, it can be provided to clamp the winding wire while no winding movement takes place, in particular while no winding support is received on the receiving device, in order thus to prevent movement of the winding wire relative to the respective wire supply means along or counter to the feed direction.

In each, individual or one winding device, at least one preforming element which is movable relative to the wire supply means of the winding device can be provided and can be movable between a rest position and an engagement position, wherein the preforming element in its engagement position is able to exert a transverse force on the winding wire and thus an elastic to plastic prestressing which has a lasting influence on the behavior of the winding wire when it strikes a winding support received on the receiving device and during the progressive formation of a coil winding in such a way that the tendency of the laid winding wire to form bulges between bending points is fully or sufficiently partially compensated. Thus, the respective winding device can be configured for the contour-conforming laying of strand-shaped material, namely the winding wire, on non-circular support bodies, namely a tooth of a winding support received on the receiving device, wherein, in particular, a bulging of the wound-up winding material is minimized. In this context, the embodiments described for such a winding device in document EP 2 309 626 A1 can be correspondingly provided.

The receiving device can be configured for receiving an externally grooved winding support of a traction drive, in particular of a separately excited traction drive, and the winding device can be configured in each case for forming coil windings around winding teeth of an externally grooved winding support of a traction drive, in particular of a separately excited traction drive. It is thus provided that a winding support of a traction drive is arranged on the receiving device and coil windings are wound thereon. Correspondingly, it can be provided in the method according to the disclosure that coil windings are produced on an externally grooved winding support of a rotor or stator of a traction drive. According to the disclosure, a traction drive is understood to mean a drive which brings about a power-operated locomotion of a vehicle. For example, a traction drive can drive a rotation of wheels of a vehicle (passenger car, truck, motorcycle), of a ship or boat drive (propeller) or of a drive of an aircraft (for example of a propeller). In preferred embodiments, the present disclosure relates to traction drives designed as separately excited synchronous machines. For rotors of such traction drives, it is customary in the art to wind coil windings around all teeth of a winding support of the rotor one after the other by means of a single wire, with the result that the coil windings are connected in series. According to the invention, by contrast, a plurality of coil windings are wound in parallel in time, with the result that they are to be connected in accordance with the requirements of a given application after the end of the winding process.

In connection with forming coil windings around winding teeth of an externally grooved winding support of a traction drive, in particular embodiments can be provided in which the winding devices in each case have a stripping means. By selective stripping of wire ends by means of the stripping means, contacting of the wire ends for interconnection of the plurality of coil windings can be facilitated or improved. In particular, electric resistance welding of the wire ends for interconnection of the coil windings can be provided, which can be enabled or facilitated by the selective stripping by means of the stripping means. As a result of such improved contacting of the wire ends, in particular possible sources of error in the contacting can be excluded or reduced, with the result that disadvantages in relation to a winding of coil windings around all teeth of a winding support of the rotor one after the other by means of a single wire are completely or partially compensated for or avoided.

For externally grooved winding supports of separately excited synchronous machines of traction drives, usually all windings are wound one after the other by means of a single wire. From the point of view of the person skilled in the art, increased costs due to the necessity of elements for the interconnection of the windings, the risk of differences in the electrical properties of the windings due to manufacturing tolerances between different batches of the nominally identical winding wire and an increased outlay for the parallel operation of a plurality of winding machines stand counter to a time-parallel production of a plurality of windings. Surprisingly, it has been found that these disadvantages can be compensated for by the advantages of the winding technology according to the disclosure. Thus, it can be made possible by means of the winding technology according to the disclosure to individually design different windings on a winding support, for example with different wire diameter, different wires (material/construction) and/or different numbers of turns. By selective contacting and interconnection of different windings, different circuits can be made possible during operation, for example a so-called star-delta circuit. Furthermore, windings can be designed as parallel circuits, wherein a switch-over to a series circuit can be provided during operation. Thus, according to the disclosure, the production of a drive adapted individually to specific applications can be made possible. In particular, an advantageous effect can be achieved on the driving profile of a vehicle driven by means of a drive produced in this way, for example for city driving or motorway driving, and/or an efficiency of the drive can be increased.

The embodiments described above in connection with the winding device can be correspondingly provided in the method for producing coil windings on an externally grooved winding support of a rotor or stator of an electrical machine.

In the winding system according to the disclosure, it can be provided to arrange the winding machines next to one another or one above the other in such a way that the longitudinal axes of their respective receiving devices are arranged in parallel. Alternatively, an arrangement can be provided in which the longitudinal axes of the respective receiving devices lie on one another, that is to say an axial arrangement of the winding machines. As a further alternative, a matrix-like arrangement can be provided in which the winding machines are arranged in rows and columns. Preferably, the winding machines of the winding system are configured for operation at the same time, with the result that coil windings are produced at the same time on a plurality of winding supports, wherein preferably, in turn, a plurality of coil windings are produced at the same time on each of the winding supports. The winding machines of the winding system can be configured identically or according to different embodiments according to the disclosure of winding machines according to the preceding explanations.

### DESCRIPTION OF EMBODIMENTS

Further embodiments are explained in more detail below with reference to figures of a drawing. In the figures:

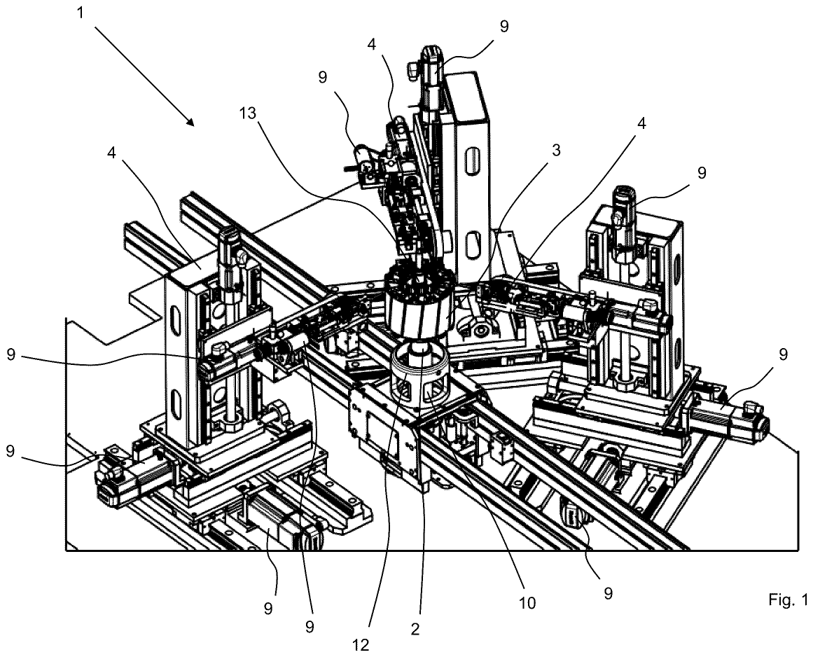

FIG. 1 a schematic illustration of a winding machine in an isometric view;

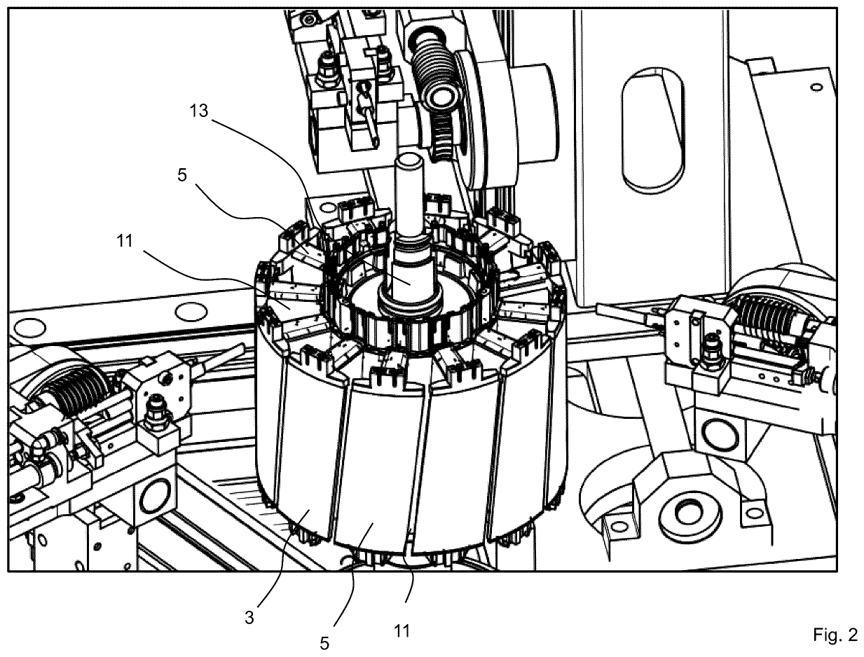

FIG. 2 a schematic illustration of an isometric detail view of a winding machine;

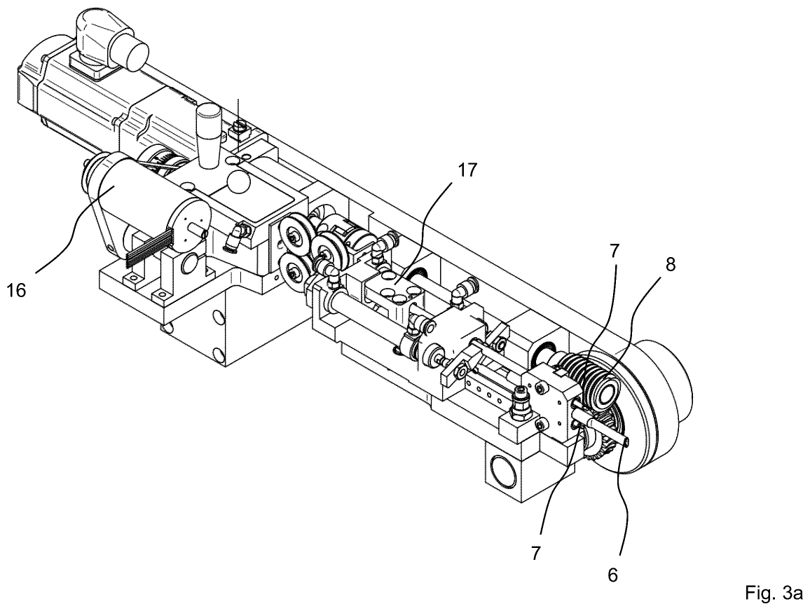

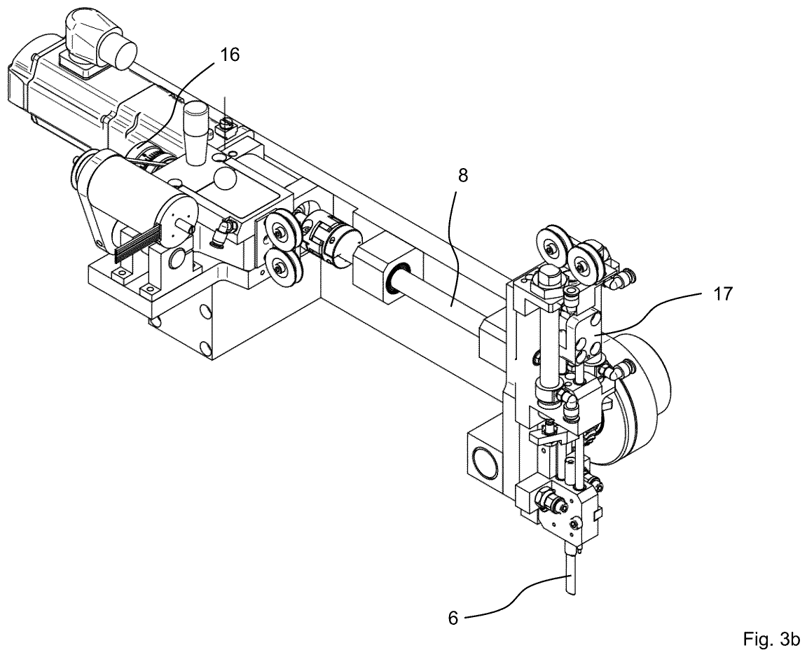

FIG. 3a a schematic illustration of a subassembly of a winding device for a winding machine;

FIG. 3b a schematic detail illustration of the subassembly from FIG. 3b with a pivoted needle;

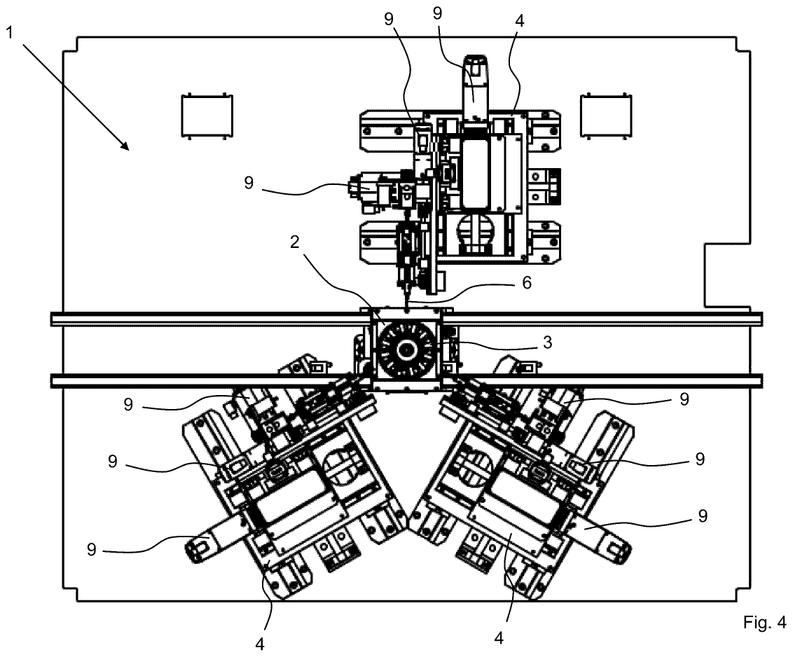

FIG. 4 a schematic illustration of a winding machine in plan view;

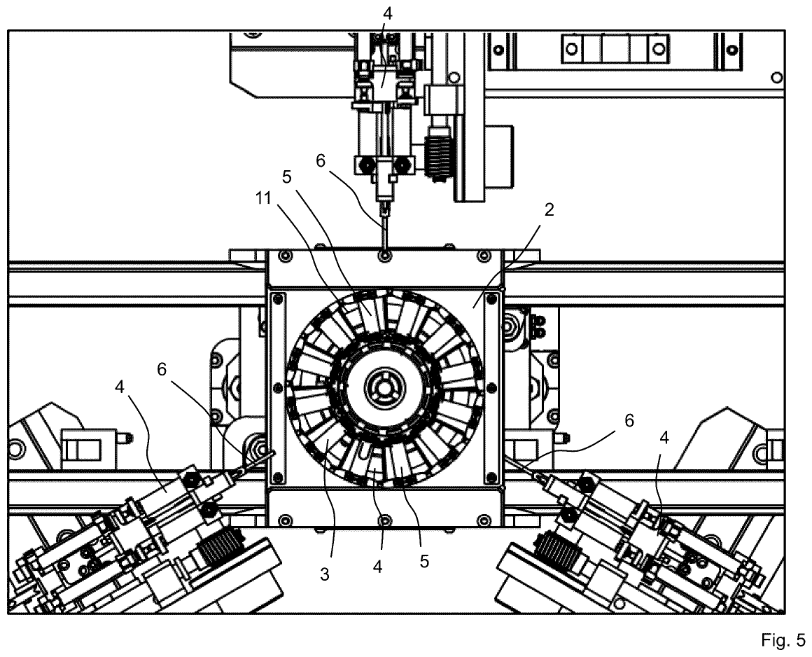

FIG. 5 a schematic detail illustration of a winding machine in plan view;

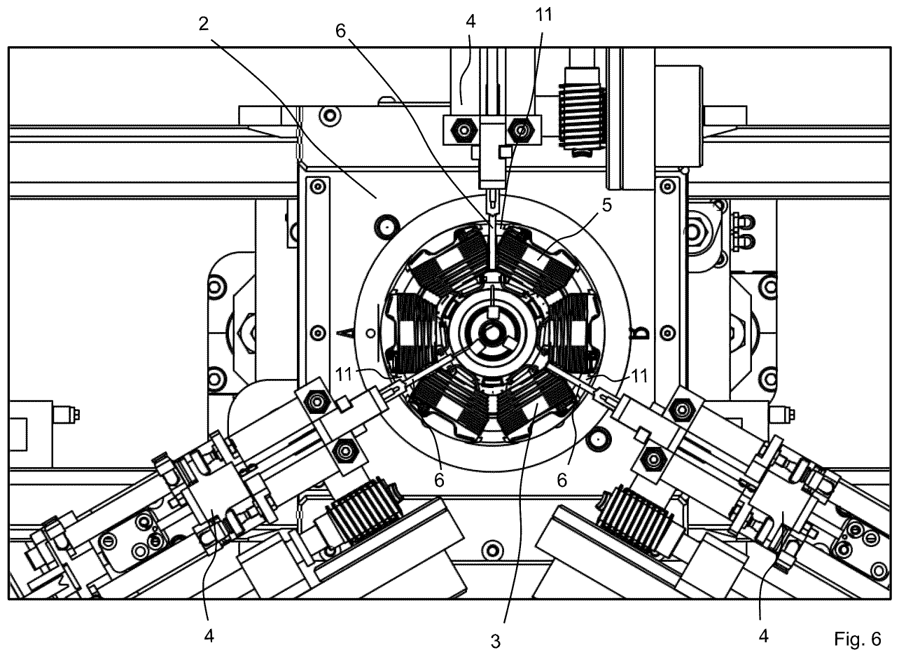

FIG. 6 a schematic detail illustration of a winding machine with wire supply means arranged in tooth interspaces of a winding support in plan view;

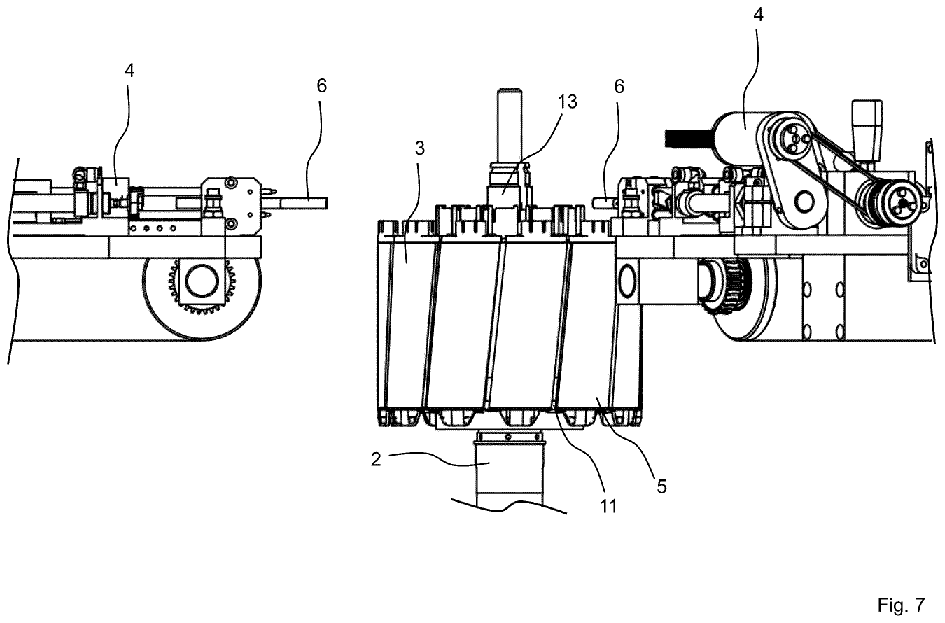

FIG. 7 a schematic detail illustration of a winding machine in a side view;

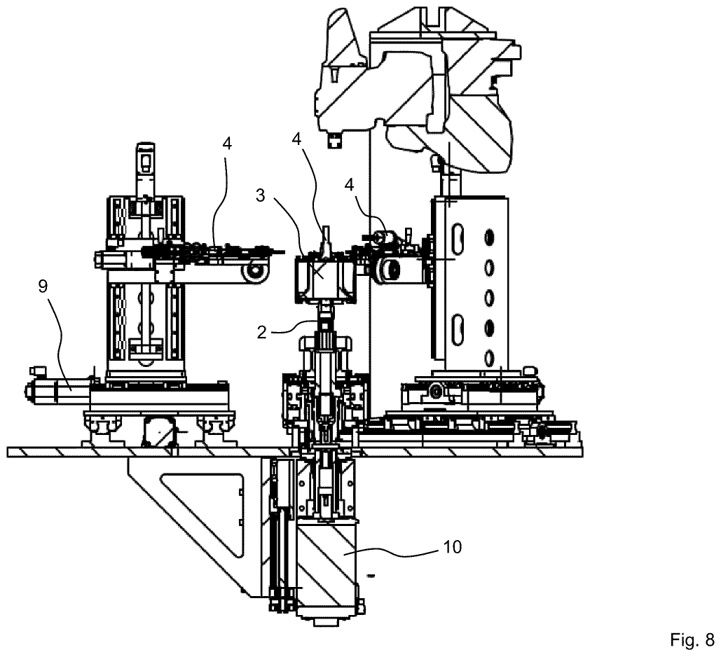

FIG. 8 a schematic illustration of a winding machine in a sectional view;

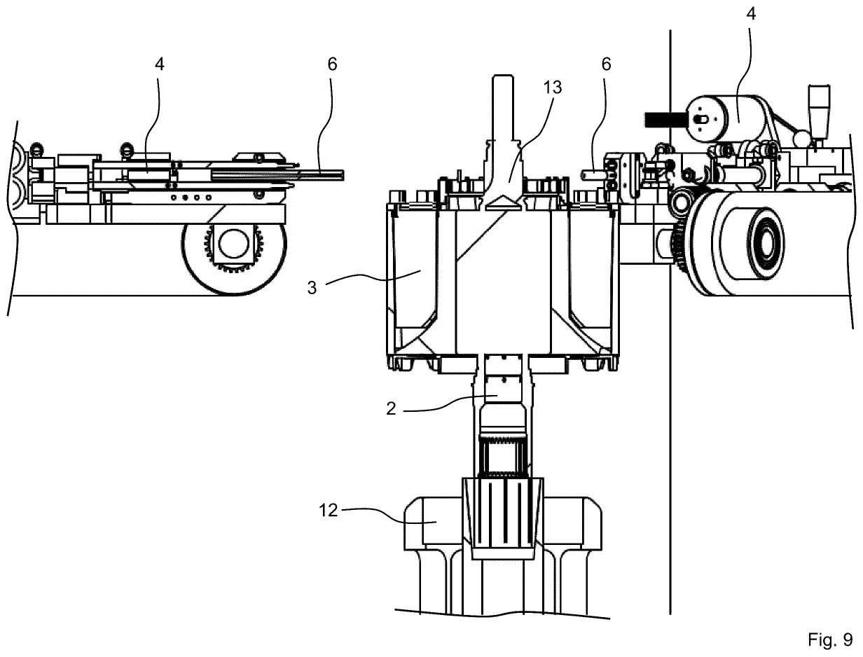

FIG. 9 a schematic detail illustration of a winding machine in a sectional view;

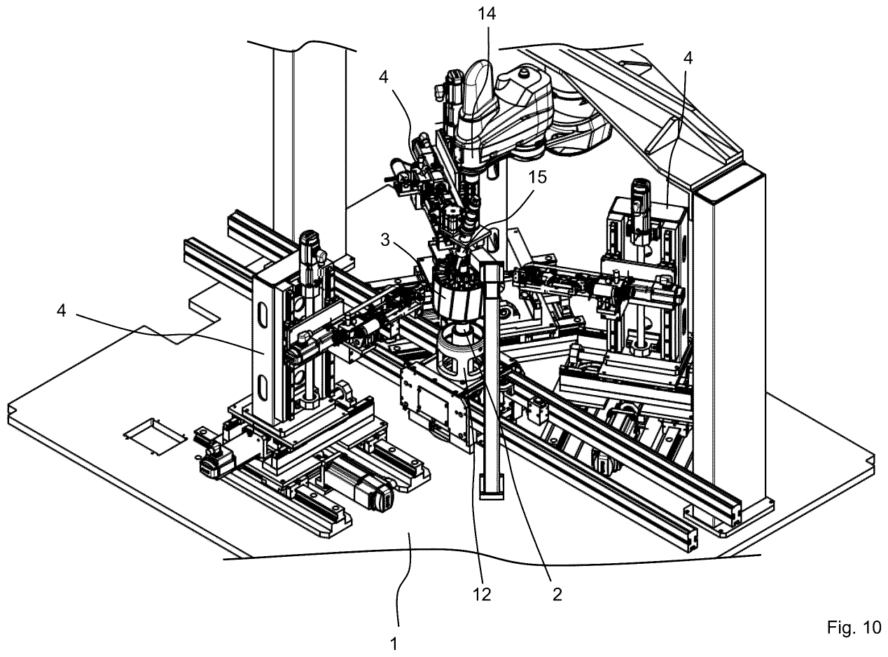

FIG. 10 a schematic illustration of a winding machine with a robotic handling device in an isometric view;

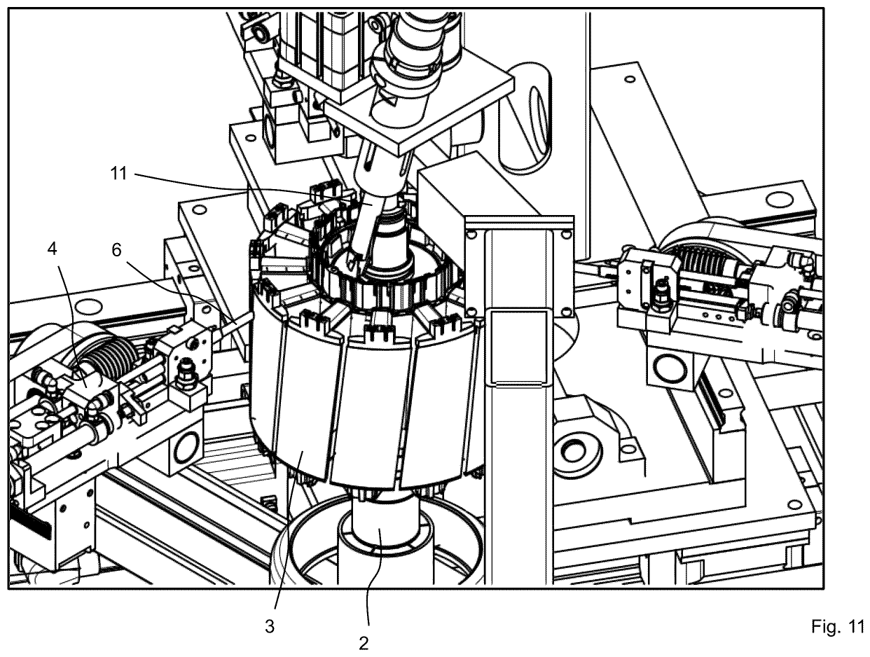

FIG. 11 a schematic detail illustration of a winding machine with a robotic handling device in an isometric view;

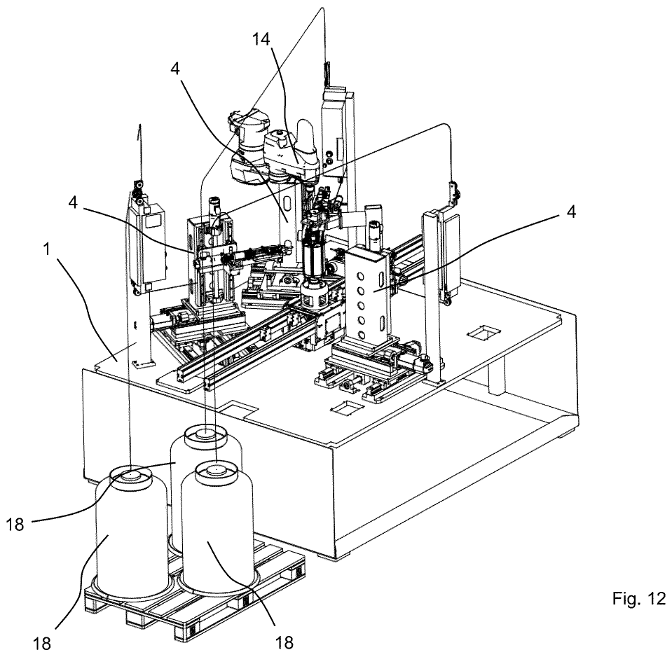

FIG. 12 a schematic illustration of a winding machine with wire stores; and

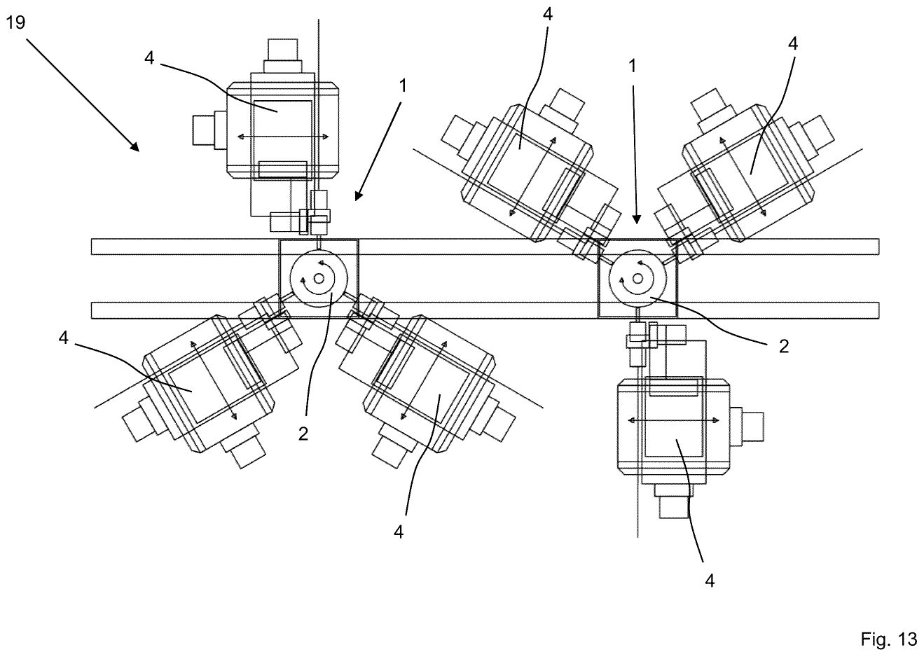

FIG. 13 a schematic illustration of a winding system with two winding machines.

FIG. 1 shows a winding machine 1 for producing coil windings on an externally grooved winding support of a rotor or stator of an electrical machine. The winding machine has a receiving device 2, on which an externally grooved winding support 3 is arranged. In the embodiment shown, the winding support 3 is a winding support of a rotor of an electric motor which forms a traction drive for an electric vehicle. Three winding devices 4, which in each case serve to form coil windings on the winding support 3, are arranged around the receiving device.

FIG. 2 illustrates a detail view of the winding machine 1. It can be seen that the winding support 3 is formed with a plurality of teeth 5, around which in each case coil windings are to be wound in order to produce a rotor. The winding devices 4 are arranged at a uniform distance along a circumferential direction of the winding support 3. Here, the winding devices 4 are configured for winding coils in accordance with the needle winding technique known per se. For this purpose, each of the winding devices 4 has a tubular wire supply means 6 as a so-called needle.

FIG. 3a shows a subassembly of a winding device 4 according to the disclosure in detail. Above and below the wire supply means 6, which in the embodiment shown has an oval tube cross section, preforming elements 7 are arranged which are movable from a rest position forwards into an engagement position. In the engagement position, a preforming element 7 exerts an elastic to plastic prestressing on a winding wire guided from the wire supply means 6 past the preforming element 7. As a result of this prestressing, the behavior of the winding wire when it strikes a tooth 5 of a winding support 3 and during the progressive formation of a coil winding is influenced in the sense of a preforming in such a way that the tendency of the laid winding wire to form bulges between bending points is fully or sufficiently partially compensated. As a result of the prevention or reduction of bulges, the space between teeth 5 of a winding support 3 can be better utilized, with the result that the winding density is increased. The function of such preforming elements 7 is described in detail in document EP 2 309 626 A1.

FIG. 3b illustrates the subassembly from FIG. 3a in a state in which the wire supply means 6 is pivoted with respect to the state shown in FIG. 3a. In order to pivot a section with the wire supply means 6, the subassembly has a pivoting mechanism 8. The pivoting takes place here in an up-down direction of the winding device, with the result that the pivot axis of the wire supply means 6 in the winding machine 1 runs perpendicularly to and at a distance from a longitudinal axis of the receiving device 2 which lies on the longitudinal or rotational axis of a winding support 3 received on the receiving device 2.

FIG. 4 shows a plan view of the winding machine 1, from which the uniform arrangement of winding devices 4 around the receiving device 2 and a winding support arranged thereon emerges clearly.

As can be seen, for example, in FIG. 1, each winding device 4 has a drive system which, in the embodiment illustrated, is formed with a plurality of drives 9 in the form of electric motors and corresponding movement transmission mechanisms. By means of the drive system, each winding device 4 is movable in relation to a winding support 3 arranged on the receiving device 2 in the axial direction, radial direction and parallel to a tangential direction of the winding support 3. The receiving device 2 has a rotary drive 10 by means of which the receiving device 2 with a winding support 3 received thereon is rotatable about the longitudinal axis of the receiving device 2 and thus a rotational axis of the winding support 3. By means of this movement, the winding of the winding support 3 in accordance with a respective winding movement of the winding devices 4 is made possible.

The winding for one of the winding devices 4 is described below. The explanations apply correspondingly to the winding movements of the further winding devices 4, in particular to simultaneous winding movements of all winding devices 4. For this purpose, the wire supply means 6 is first fed to the winding support 3. This can be seen, in particular, in FIGS. 5 and 6, wherein FIG. 5 shows the winding machine 1 before feeding the wire supply means 6 and FIG. 5 illustrates the winding machine 1 after feeding the wire supply means 6. Feeding takes place in such a way that the wire supply means 6 is arranged in an intermediate space 11 between two teeth 5 of the winding support 3. Here, feeding can take place directly into the winding support 3 between the teeth 5 or in such a way that the wire supply means 6 in plan view is arranged between the teeth 5, but above or below the winding support 3. During feeding, in particular a fine adjustment to the intermediate space 11 can be achieved by means of a movement of the winding device parallel to a tangential direction of the winding support 3.

After feeding, the wire supply means 6 is guided around one of the teeth 5 of the winding support 3, wherein a winding wire is discharged from the wire supply means by means of a feed movement such that the wire is placed around the respective tooth 5 and thus forms coil windings. Here, the wire supply means 6 is guided in the axial direction through an intermediate space 11. While the wire supply means 6 emerges upwards or downwards from the intermediate space 11, a rotation of the winding support 3 begins by means of the rotary drive 10 of the receiving device 2 until the wire supply means 6 is arranged above or below the other intermediate space 11 adjoining the respective tooth 5. By a superposition of axial movement of the wire supply means 6 and rotation of the winding support 3, the wire supply means 6 follows a movement path in the form of a segment of a circle and (rounded) corners of the respective tooth 5. In alternative embodiments, by the superposition of axial movement of the wire supply means 6 and rotation of the winding support 3, a movement path with a shape other than a shape of a segment of a circle can also be provided, for example with an elliptical shape or corresponding to a functional equation. Subsequently, the wire supply means 6 is guided axially through the other intermediate space 11 and fed back to the first-mentioned intermediate space by means of a rotation of the receiving device 2 with the winding support 3. Coil windings are placed around the tooth 5 by the repetition of this winding movement. In FIG. 6, coil windings already wound around the teeth 5 of the winding support 3 can be seen.

In the embodiments of FIGS. 1 and 2, it can be seen that an obliquely grooved winding support 3 is received on the receiving device 2. For this reason, the winding support 3 is additionally also rotated by means of the rotary drive 10 during the axial movement of the wire supply means 6 through the respective groove 11, with the result that the wire supply means 6 follows the oblique groove profile. This rotation can be omitted for straight grooved winding supports. In embodiments, the rotation for feeding to another intermediate space 11 takes place only after the wire supply means 6 has completely emerged from the intermediate space 11 and without temporal overlap, with the result that the movement path of the wire supply means 6 has a corner. Such embodiments can be provided, for example, in the case of non-rounded tooth edges, or if a movement along a rounded path is dispensable for other reasons.

In embodiments in which the winding devices 4 are formed with a respective pivoting mechanism 8 for the pivoting of the wire supply means 6, the winding movement can be modified and thereby optimized by means of the pivoting movement.

Since each of the winding devices 4 has its own drive system, they can carry out the winding movement autonomously from the other winding devices 4, with the exception of the rotation of the receiving device 2.

The receiving device 2 has a workpiece support 12 on which a winding support 3 is initially received. For this purpose, the workpiece support 12 can be separable from the receiving device 2 or the winding support is arranged directly on the receiving device 2 on the workpiece support 12. Before the beginning of the winding, a receiving shaft 13 of the receiving device 2 is guided through a central bore of the winding support 3 and the winding support 3 is lifted out of the workpiece support 12 by means of a shoulder of the receiving shaft 13. During the winding, the receiving shaft 13 is driven and rotated by means of the rotary drive 10, as a result of which it brings about a rotation of the winding support 3 which is received on the receiving shaft 13 in a manner preventing a relative rotation between receiving shaft 13 and winding support 3. The receiving shaft can have a clamping device for fixing the winding support 3. Winding supports which are already formed or connected to a shaft can also be provided. In this case, the shaft of the winding support can be received on its outer diameter on the receiving device 2, for example in a clamping device.

FIG. 7 shows a detail view of the winding machine 1 from the side. FIG. 8 illustrates a side view in section. FIG. 9 is a sectioned detail view from the side of a winding machine 1.

FIG. 10 illustrates a further winding machine 1. In comparison with the winding machine 1 shown in FIG. 1, the winding machine according to FIG. 10 has a robot arm 14, on which a handling device 15 for wire ends is arranged. FIG. 11 shows a detail view in which the arrangement of the handling device 15 on a winding support 3 received on the receiving device 2 can be seen.

By means of the handling device 15, a starting end of a winding wire of a partial winding is fixed on a contact point of the winding support 3, so that the winding process can begin with the mechanical wire pull necessary for this purpose. The contact point is an electrical contacting point, in which the preferably stripped wire is inserted. After the wire has been inserted into the contact point with the aid of the winding device 4, the handling device 15 is used to crimp on the contact point in order to fix the wire mechanically in the contact point. Thereafter, any wire overhang remaining from the contact point on the side not leading to the coil is gripped and severed by means of the handling device 15. Only then does the wire feed and winding process begin. In the embodiment shown, the winding machine 1 has only one robot arm 14 with handling device 15. For this reason, the process of fixing for the number of winding devices 4 takes place one after the other. This applies similarly to the mechanical fixing of an end end of a wire of a partial winding only in the reverse form. The winding device 4 places the end end in a corresponding contact point. Thereafter, the contact point is pinched on or crimped with the handling device 15, so that the wire is fixed mechanically. Thereafter, the connecting wire between the contact point and the wire supply means 6 on the side not leading to the coil is severed with the handling device 15. The winding process of this partial coil is thus concluded. This process also takes place one after the other for the number of winding devices 4.

Provision can be made to insert the starting end into the contact element without a significant projection and then to pinch on the contact element. Thus, the winding process can begin immediately without first gripping a wire end with the robot unit, severing a wire and disposing of it. Thus, a wire-loss-free mode of operation can be provided in which no wire sections are severed and disposed of.

The above-described functions of the handling device 15, in particular in accordance with a wire-loss-free mode of operation, can be provided in different embodiments of a winding machine according to the disclosure, in particular also in other embodiments than those illustrated in the figures. Here, the functions can also be provided in a different manner than by means of the described handling device 15, in particular by means of corresponding alternative devices, for example by a corresponding handling device for each of the winding devices 4.

The winding device 4 with the subassembly shown in FIGS. 3a and 3b has a stripping means 16 by means of which insulation of the winding wire used can be removed. In particular, by means of the stripping means 16, the insulation at starting ends and end ends of the winding wire is removed in order to enable or to facilitate contacting of the coil windings, for example via the above-described contact points. Furthermore, the winding device according to FIGS. 3a and 3b has a wire clamping means 17 by means of which the winding wire can be clamped in order to prevent movement of the wire along or counter to a supply direction. In particular, provision can be made to clamp the winding wire when no winding movement takes place and to release the wire by the wire clamping means 17 only when the starting end of the wire is clamped in the contact point, and to clamp the wire by means of the wire clamping means 17, before the wire is severed after fixing the end end in the contact point.

FIG. 12 shows a winding machine 1 with wire stores 18 in the form of wire rolls, from each of which a respective winding wire is supplied to a winding device 4, which winding wire is wound around a tooth 5 of a winding support 3 by means of the respective winding device 4.

A winding system 19 according to the disclosure is shown in FIG. 13. The winding system is formed with two winding machines 1 which are arranged with respect to one another in such a way that longitudinal axes of the receiving devices 2 and thus rotational axes of winding supports 3 received thereon are aligned in parallel. Thus, in the winding system 19, coil windings can be produced on two winding supports 3 in parallel in time, wherein coil windings are produced simultaneously on a plurality of teeth 5 on each of the winding supports 3.

The features disclosed in the above description, the claims and the drawing can be significant both individually and in any combination for the realization of the various embodiments.

1. A winding machine for producing coil windings on an externally grooved winding support of a rotor or stator of an electrical machine, comprising:
a receiving device for receiving an externally grooved winding support, wherein the receiving device has a longitudinal axis which, in a state in which an externally grooved winding support is received on the receiving device, lies on a longitudinal axis of the externally grooved winding support; and
a plurality of winding devices arranged around the receiving device, wherein
each of the winding devices has a wire supply means which is configured to move a winding wire along a feed direction and thus to guide the winding wire towards the receiving device,
each of the winding devices has a drive system which is configured to move the wire supply means relative to the receiving device and independently of the wire supply means of the other winding devices during a feed movement of the winding wire in accordance with a winding movement in such a way that the winding wire is wound around a winding tooth of an externally grooved winding support received on the receiving device in order to form a coil winding, and
the receiving device has a rotary drive by means of which the receiving device is rotatable about its longitudinal axis and which is configured to rotate the receiving device in accordance with the winding movement in such a way that the respective winding wire is wound around the respective winding tooth of the externally grooved winding support received on the receiving device in order to form a respective coil winding.

2. The winding machine according to claim 1, wherein the winding machine has at least three winding devices.

3. The winding machine according to claim 1, wherein the winding devices are arranged uniformly distributed around the receiving device in relation to the circumference of a winding support to be arranged in the receiving device.

4. The winding machine according to claim 1, wherein the receiving device has a workpiece support which is configured for receiving an externally grooved winding support and is arranged releasably in the winding machine in order to enable transport of an externally grooved winding support received on the workpiece support to and from the winding machine.

5. The winding machine according to claim 1, wherein, for each of the winding devices, the drive system is configured to move the wire supply means in accordance with the winding movement relative to the receiving device
in a first direction which runs parallel to the longitudinal axis of the receiving device, and
in a second direction which runs perpendicular to the longitudinal axis of the receiving device and through the longitudinal axis of the receiving device.

6. The winding machine according to claim 5, wherein each of the winding devices is movable in a third direction which runs perpendicular to the first direction and perpendicular to the second direction.

7. The winding machine according to claim 1, wherein, for each of the winding devices, the drive system is configured to pivot the wire supply means about a pivot axis which runs perpendicular to and at a distance from the longitudinal axis of the receiving device.

8. The winding machine according to claim 1, wherein each of the winding devices has a stripping means which is configured to remove insulation of the winding wire.

9. The winding machine according to claim 1, wherein each of the winding devices has a wire clamping means which is configured to clamp the winding wire and thus to prevent movement of the winding wire along the feed direction.

10. The winding machine according to claim 1, wherein, for each winding device, at least one preforming element which is movable relative to the wire supply means of the winding device is provided and is movable between a rest position and an engagement position, wherein, in its engagement position, the preforming element is able to exert a transverse force on the winding wire and thus an elastic to plastic prestressing which has a lasting influence on the behaviour of the winding wire when it strikes a winding support received on the receiving device and during the progressive formation of a coil winding in such a way that the tendency of the laid winding wire to form bulges between bending points is fully or sufficiently partially compensated.

11. The winding machine according to claim 1, wherein the receiving device is configured for receiving an externally grooved winding support of a traction drive and the winding devices are each configured for forming coil windings around winding teeth of an externally grooved winding support of a traction drive.

12. A winding system comprising a plurality of winding machines according to claim 1, wherein the winding machines are configured for producing coil windings in parallel on a respective externally grooved winding support of a rotor or stator of an electrical machine in the winding system (17).

13. A method for producing coil windings on an externally grooved winding support of a rotor or stator of an electrical machine, comprising the steps of
receiving an externally grooved winding support on a receiving device of a winding machine in such a way that a longitudinal axis of the receiving device lies on a longitudinal axis of the externally grooved winding support; and
simultaneously forming a plurality of coil windings around a respective winding tooth of the externally grooved winding support by means of a plurality of winding devices of the winding machine arranged around the receiving device, wherein in this case, in order to form a respective coil winding by means of a respective winding device
a winding wire is moved along a feed direction by means of a wire supply means of the respective winding device and is thus supplied to the respective winding tooth,
during the feed movement of the winding wire, the wire supply means of the respective winding device is moved in accordance with a winding movement by means of a drive system of the respective winding device relative to the respective winding tooth and independently of the wire supply means of the other winding devices and is thus wound around the respective winding tooth, and
the externally grooved winding support is rotated in accordance with the winding movement by means of a rotary drive of the receiving device in such a way that the respective winding wire is wound around the respective winding tooth of the externally grooved winding support in order to form the respective coil winding.

14. The method according to claim 13, wherein coil windings are produced on an externally grooved winding support of a rotor or stator of a traction drive.
